(19) United States
(12) Patent Application Publication
(10) Pub. No.: US 2020/0327628 A1
(43) Pub. Date: Oct. 15, 2020

(54) SYSTEM FOR CUSTOMIZED TRAVEL MANAGEMENT

(71) Applicant: Walmart Apollo, LLC, Bentonville, AR (US)

(72) Inventors: Mainak Mitra, Kolkata (IN); Ritish Menon, Bengaluru (IN); Riyanka Bhowal, West Bengal (IN); Somedip Karmakar, Kolkata (IN); Debanjana Banerjee, Kolkata (IN)

(21) Appl. No.: 16/423,015

(22) Filed: May 26, 2019

(30) Foreign Application Priority Data
Apr. 9, 2019 (IN) 201941014278

(51) Int. Cl. G06Q 50/14; G06F 9/451; G06Q 30/02; G06Q 10/02; G06Q 30/06

(52) U.S. Cl. CPC G06Q 50/14; G06F 9/451; G06F 16/22; G06Q 10/02; G06Q 30/0631; G06Q 30/0201

(57) ABSTRACT

Examples a system for customized travel planning management. The system extracts relevant travel-related data from travel-related provider contracts. The extracted relevant travel-related data and historical travel usage data are analyzed to calculate a market share for each provider. A booking manager identifies recommended travel-related provider pairs associated with a set of travel dates within a predetermined range of a user-selected preferred date of travel associated with a user-selected source-to-destination pair based on the calculated market share for each provider and user-provided travel preferences. The system books the user's selected accommodations provider and travel provided on a recommended booking date. An optimization component identifies recommended future negotiation terms associated with at least one provider in the set of travel-related providers based on the historical travel usage data, historical transaction data and historical contract compliance data.

### BACKGROUND

Large organizations having a number of members that frequently travel sometimes enter into contracts with airlines, hotel chains and other travel-related service providers to obtain discounts or other incentives based on large volume of usage associated with services provided by these providers. These agreements can specify minimum usage commitments by the organization members to obtain the negotiated discounts/incentives. However, due to the large numbers of individual members traveling during a variety of different times and locations, it can be difficult to determine if and when the minimum usage commitments are met. Moreover, the individual members may not be aware of the incentives or discounts available to them if they utilize certain providers or combinations of providers. Therefore, available discounts may go unused and/or the minimum usage commitments may not be satisfied due to suboptimal travel-related provider usage. Moreover, manual planning and scheduling of travel arrangements can be a tedious, time-consuming and inefficient process for human users.

### SUMMARY

Some examples provide a system for customized travel planning management. The system includes at least one processor communicatively coupled to a memory. A contract manager component extracts relevant travel-related data from a set of travel-related provider contracts. The contract manager component stores the extracted data on a data storage device. An audit component analyzes the extracted relevant travel-related data and historical travel usage data to calculate a market share for each provider in a travel-related providers. The set of travel-related providers includes a set of accommodations providers and a set of travel providers. A booking manager component analyzes a set of user-provided travel preferences and the calculated market share using the extracted relevant travel-related data to identify a set of recommended air travel and accommodations provider pairs associated with a set of travel dates within a predetermined range of a user-selected preferred date of travel associated with a user-selected source-to-destination pair on a user interface device associated with the user. An optimization component generates a set of recommended future negotiation terms associated with at least one provider in the set of travel-related providers based on the historical travel usage data, historical transaction data and historical contract compliance data.

Other examples provide a computer-implemented method for managing customized travel plans. A user interface device receives a set of user-provided travel preferences, including a source-to-destination pair identifying a point of departure and a travel destination, a user-preferred date of travel, an acceptable threshold range of travel dates and a user-preferred class of travel from a user. A contract manager component analyzes relevant travel-related data extracted from a set of travel-related provider contracts with historical transaction data associated with air travel and accommodations usage to calculate market share for each provider in a set of travel-related providers. A booking component generates a set of recommended travel-related provider pairs compliant with the user-provided travel preferences. The set of recommended travel-related provider pairs includes a travel provider associated with the source-to-destination pair and class of travel and an accommodations provider associated with the destination and a set of travel dates within the acceptable threshold range of travel dates. A reservation component books travel and accommodations associated with an air travel provider and accommodations provider selected from the set of recommended travel-related provider pairs for a travel date selected from the set of travel dates.

Still other examples provide a computer storage media, having computer-executable instructions for customized disposition of a returned item. The computer-executable instruction are executed by a computer to cause the computer to extract relevant travel-related data from a set of travel-related provider contracts in a portable document format (PDF) format. The extracted travel-related data and historical travel usage data is analyzed to calculate a market share for each provider in a set of travel-related providers. A set of recommended future negotiation terms associated with at least one provider in the set of travel-related providers is generated based on the historical travel usage data, historical transaction data and historical contract compliance data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for customized travel management.

FIG. 2 is an exemplary block diagram illustrating a travel manager component.

FIG. 3 is an exemplary block diagram illustrating a travel manager component for extracting travel-related data from contracts.

FIG. 4 is an exemplary block diagram illustrating a travel manager component for booking user-selected travel and accommodations.

FIG. 5 is an exemplary block diagram illustrating a set of travel-related provider pairs.

FIG. 6 is an exemplary block diagram illustrating a database storing travel-related data.

FIG. 7 is an exemplary block diagram illustrating travel-related provider contract optimization by a travel manager component.

FIG. 8 is an exemplary block diagram illustrating travel booking by a travel manager component.

FIG. 9 is an exemplary flow chart illustrating operation of the computing device to book travel and accommodations for a user.

FIG. 10 is an exemplary flow chart illustrating operation of the computing device to generate a set of recommended negotiation terms.

FIG. 11 is an exemplary graph illustrating objective function for contract optimization.

FIG. 12 is an exemplary screenshot illustrating a home page for a travel manager system.

FIG. 13 is an exemplary screenshot illustrating audit analysis inputs and metrics.

FIG. 14 is an exemplary screenshot illustrating audit analysis market share and discount.

FIG. 15 is an exemplary screenshot illustrating audit analysis discount over service class.

FIG. 16 is an exemplary screenshot illustrating contract optimization.

FIG. 17 is an exemplary screenshot illustrating dollar impact for contract optimization.

FIG. 18 is an exemplary screenshot illustrating contract data extraction.

FIG. 19 is an exemplary screenshot illustrating contract data extraction and deletion.

FIG. 20 is an exemplary table illustrating discount difference data.

FIG. 21 is an exemplary table illustrating market share audit reporting data.

FIG. 22 is an exemplary screenshot illustrating alert notification.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enable customized travel management system for optimizing travel-related services available from one or more providers. In some examples, the system manages airline and/or hotel booking based on contract terms to obtain best available discounts, incentives or other advantages. A travel manager component compares travel requirements of users and contract commitments with providers in some examples to identify optimal combinations of providers, travel dates and source-destination pairs. The recommended providers and/or travel and booking dates are output to the users to improve user efficiency via the travel and booking interface.

An audit component in other examples identifies realized discount rates for different source-destination pairs and/or different providers. This information can be used to optimize future contract negotiations and improve fulfillment of provider contract commitments.

Other examples provide a contract manager component that extracts key contract terms and/or conditions from travel providers and accommodations providers. These extracted travel-related terms and data are stored in a database for easy access during travel booking and auditing operations.

Still other examples provide a travel booking component that identifies a best/recommended combination of a travel provider and accommodations provider and/or a recommended booking date to optimize incentives available from the providers and/or ensure fulfillment of commitments with the providers. A travel provider and an accommodations provider in some examples could include an airline and a hotel. This maximizes available benefits usage while minimizing user interaction/effort required to identify travel-related provider pairs suitable to meet the user's travel-related needs and preferences.

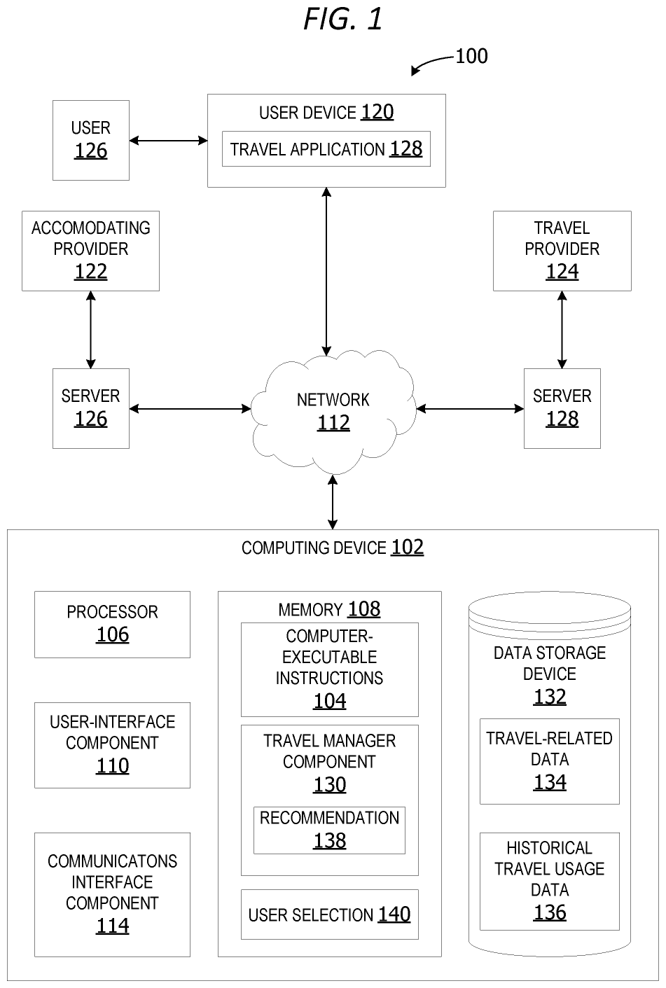

Referring again to FIG. 1, an exemplary block diagram illustrates a system 100 for customized travel management. In the example of FIG. 1, the computing device 102 represents any device executing computer-executable instructions 104 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 in other examples includes a user interface component 110.

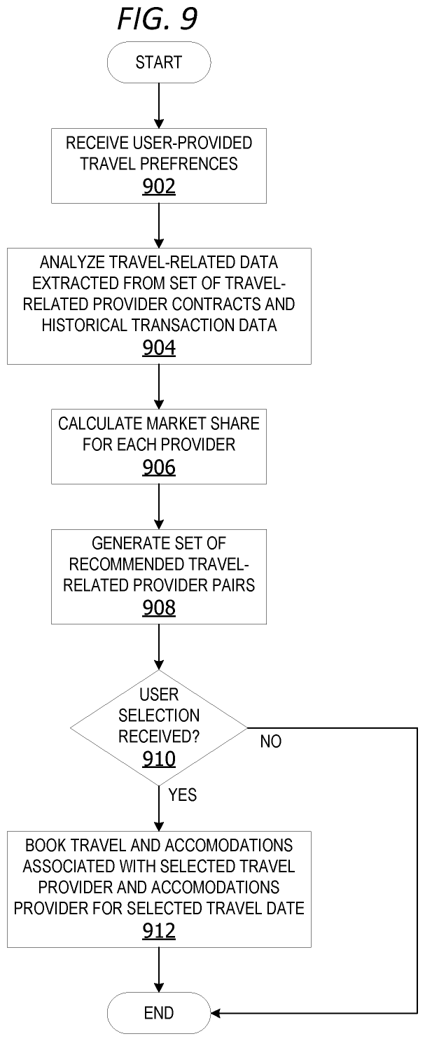

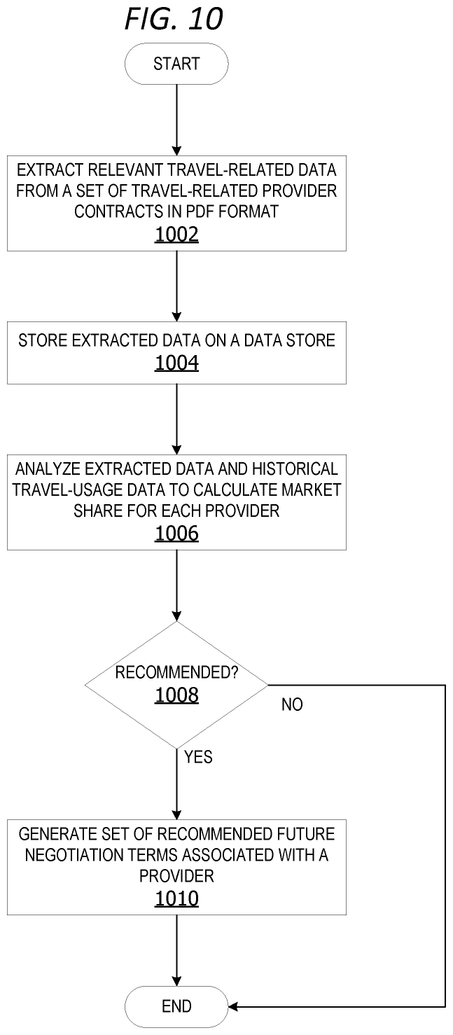

The processor 106 includes any quantity of processing units, and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 9 and FIG. 10).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface component 110 includes a graphics card for displaying data to the user and receiving data from the user. The user interface component 110 can also include computer-executable instructions (e.g., a driver) for operating the graphics card. Further, the user interface component 110 can include a display (e.g., a touch screen display or natural user interface) and/or computer-executable instructions (e.g., a driver) for operating the display. The user interface component 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to a server 116, a server 118 and/or a user device 120, can occur using any protocol or mechanism over any wired or wireless connection. In some examples, the communications interface component 114 is operable with short range communication technologies such as by using near-field communication (NFC) tags.

The server 116 and the server 118 can be any type of computing device or cloud server accessible via the network. In this example, the server 116 represents one or more computing devices associated with an accommodations provider 122. The accommodations provider 122 includes one or more providers of accommodations, such as, but not limited to, a hotel chain.

The server 118 in a non-limiting example, represents one or more computing devices associated with a travel provider 124. The travel provider 124 represents one or more travel providers, such as, but not limited to, an airline or a passenger railroad service.

The user device 120 represent any device executing computer-executable instructions associated with a user 126. The user device 120 can be implemented as a mobile computing device, such as, but not limited to, a wearable computing device, a mobile telephone, laptop, tablet, computing pad, netbook, gaming device, and/or any other portable device. The user device 120 includes at least one processor and a memory. The user device 120 can also optionally include a user interface component.

In some examples, the user device 120 is implementing a travel application 128 for sending data to a travel manager component 130 and/or receive data from the travel manager component 130 executing on the computing device 102.

The system 100 can optionally include a data storage device 132 for storing data, such as, but not limited to travel-related data 134 and/or historical travel-related usage data 136. The travel-related data 134 is data extracted from one or more travel-related service provider contracts. A travel-related service provider includes accommodation providers and/or travel providers, such as, but not limited to, the accommodation provider 122 or the travel provider 124. The historical travel usage data 136 is data associated with previous usage of services provided by one or more accommodations providers and/or travel providers. In other words, the historical travel usage data 136 includes records associated with previous air travel and hotel stays.

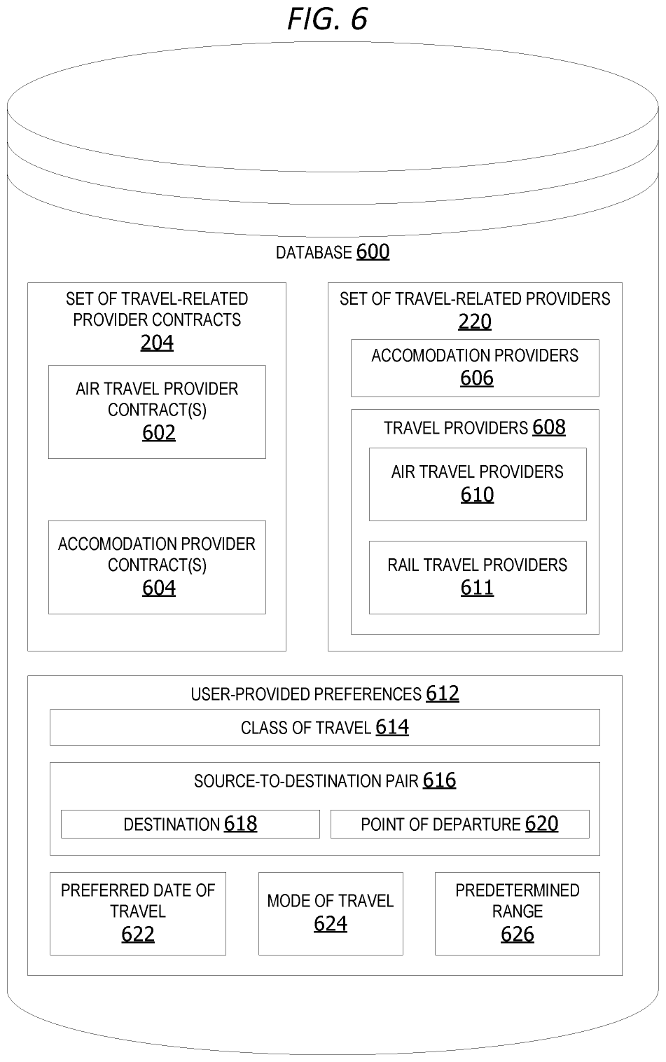

The data storage device 132 can include one or more different types of data storage devices, such as, for example, one or more rotating disks drives, one or more solid state drives (SSDs), and/or any other type of data storage device. The data storage device 132 in some non-limiting examples includes a redundant array of independent disks (RAID) array. In other examples, the data storage device 132 includes a database, such as, but not limited to, the database 600 in FIG. 6 shown below.

The data storage device 132 in this example is included within the computing device 102 or associated with the computing device 102. In other examples, the data storage device 132 includes a remote data storage accessed by the computing device via the network 112, such as a remote data storage device, a data storage in a remote data center, or a cloud storage.

The memory 108 in some examples stores one or more computer-executable components, such as, but not limited to, the travel manager component 130. In some examples, the travel manager component 130 analyzes the travel-related data 134, the historical travel usage data 136, travel schedules, room availabilities, planned travel dates, user travel preferences, and any other travel-related data to generate a recommendation 138. The recommendation 138 includes a recommended accommodation (hotel), recommended airline, recommended dates of travel (departure) and/or recommended booking date(s). The recommended booking date is a date on which to make a reservation or schedule a flight.

The user 126 reviews the recommendation 138 and makes a user-selection of a date of departure, travel provider 124, accommodations provider, and booking date. The travel manager component 130 makes the reservations (books flight and makes hotel reservations) autonomously on the user-selected booking date.

In other examples, the travel manager component 130 analyzes the travel-related data and/or historical travel usage data 136 to generate a recommendation 138 including recommended negotiation terms for future travel-related provider contracts with travel providers and/or accommodations providers.

The travel manager component 130 in some examples, receives a set of user-provided travel preferences from the user 126 via the user interface component 110. In other examples, the travel manager component 130 receives the user-provided travel preferences from the user 126 via the communications interface component 114. In this example, the user enters/selects travel preferences using the travel application 128. The travel application 128 transmits the preferences to the travel manager component 130 via the network 112.

The set of user-provided travel preferences can include, without limitation, a source-to-destination pair, a user-preferred date of travel, an acceptable threshold range of travel dates and/or a user-preferred class of travel. The source-to-destination pair includes identifying a point of departure and a travel destination.

The travel manager component 130 analyzes relevant travel-related data and historical transaction data associated with past air travel and accommodations usage by users to calculate market share for each provider in a set of travel-related providers. All those inputs go into the booking management component and ends with the best combination of airline and hotel for a particular trip. The market share is the percentage usage committed to a certain travel provider or accommodations provider to get a discount.

The travel-related data is extracted from a set of travel-related provider contracts. The travel manager component 130 generates a set of recommended travel-related provider pairs compliant with the user-provided travel preferences. Each pair in the set of recommended travel-related provider pairs includes a travel provider associated with the source-to-destination pair and class of travel. Each pair also includes an accommodations provider associated with the destination and an arrival date within the acceptable threshold range of travel dates. The travel manager component 130 books (schedules) travel and accommodations associated with an air travel provider and accommodations provider selected by the user 126 from the set of recommended travel-related provider pairs for a travel date selected by the user 126 from the set of travel dates.

In other examples, the travel manager component 130 extracts relevant travel-related data from a set of travel-related provider contracts in a PDF format. The travel manager component 130 stores the extracted relevant travel-related data on the data storage device 132. The travel manager component 130 analyzes the extracted relevant travel-related data 134 and the historical travel usage data 136 to calculate a market share for each provider in a set of travel-related providers, such as, but not limited to, the accommodations provider 122 and/or the travel provider 124. The travel manager component 130 generates a set of recommended future negotiation terms associated with at least one travel-related provider based on the historical travel usage data 136, historical transaction data and historical contract compliance data.

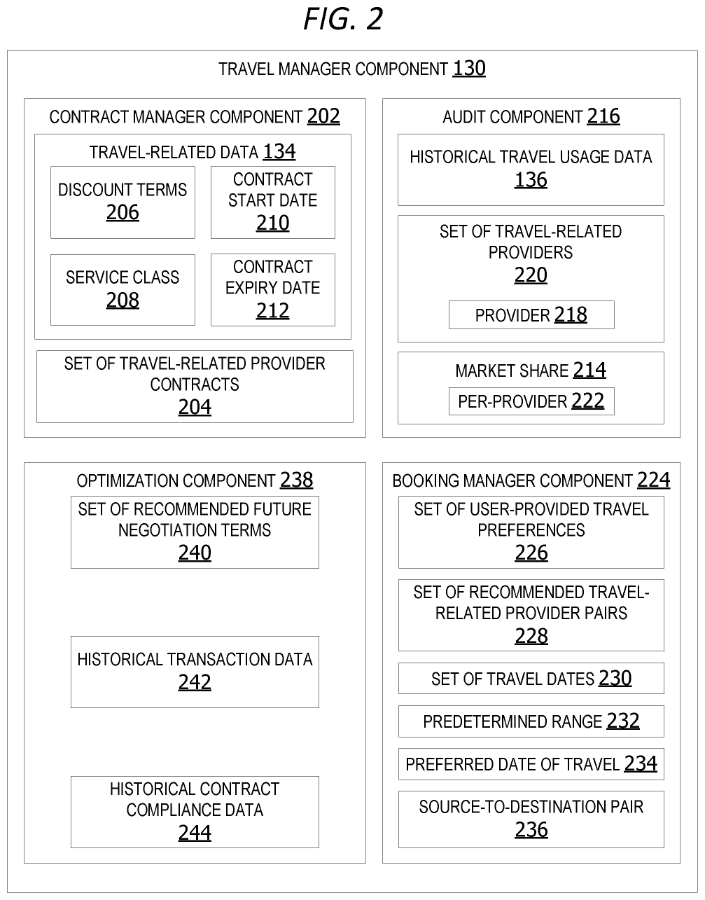

FIG. 2 is an exemplary block diagram illustrating a travel manager component 130. A contract manager component 202 extracts relevant travel-related data 134 from a set of travel-related provider contracts 204. The travel-related data 134 can include, for example but without limitation, discount terms 206, service class 208, contract start date 210, contract expiry date 212, market share 214 or any other travel-related data. The service class refers to class or type of service, such as, but not limited to, first class, business class, economy class, etc.

The set of travel-related provider contracts 204 includes a set of air-travel provider contracts and a set of accommodations provider contracts. In other examples, the set of travel-related provider contracts 204 can also include contracts with passenger train travel providers or any other type of travel or accommodations providers.

An audit component 216, in other examples, analyzes the extracted travel-related data 134 and historical travel usage data 136. The audit component 216 calculates the market share 214 for each provider 218 in a set of travel-related providers 220. The set of one or more travel-related providers includes a set of one or more accommodations providers and a set of one or more travel providers. The market share is a per-provider 222 market share.

A booking manager component 224 analyzes a set of user-provided travel preferences 226 and the calculated market share 214 for each provider using the extracted relevant travel-related data 134. The user-provided travel preferences is a set of one or more travel preferences selected by a user. The user-provided travel preferences can include the source-to-destination pair, the user-preferred date of travel, preferred departure location, and a user-preferred class of travel. The user-preferred date of travel can include a date of departure and/or a date of arrival. The preferred departure location can include the location of an airport, train station, bus station or other location at which the user prefers to arrive or depart.

The booking manager component 224 identifies a set of recommended travel-related provider pairs 228 associated with a set of travel dates 230 within a predetermined range 232 of a user-selected preferred date of travel 234 associated with a user-selected source-to-destination pair 236 based on the analysis results.

A recommended travel-related provider pairs includes a travel provider and an accommodations provider. In some examples, the recommended travel-related provider pairs also includes an air travel provider, an accommodations provider associated with the destination, a set of alternative travel dates within a threshold range of the user-provided preferred travel date and a recommended booking date.

The travel manager component 130 outputs the set of recommended travel-related provider pairs 228 on a user interface device associated with the user, such as, but not limited to, the user interface device 110 in FIG. 1.

An optimization component 238 generates a set of recommended future negotiation terms 240 associated with at least one provider in the set of travel-related providers based on the historical travel usage data 136, historical transaction data 242 and/or historical contract compliance data 244.

In some examples, the optimization component 238 suggests or recommends optimal discount rates based on each market pair for the respective airline contracts and optimal discount rates for each hotel for the respective contracts with the hotel chains. The Optimization component 238 in these non-limiting examples takes into consideration past travel transactions, historical contract information, and forecasted demand and price to provide the best realistic discounts within the negotiation realm to ensure maximum savings for the user or travel team.

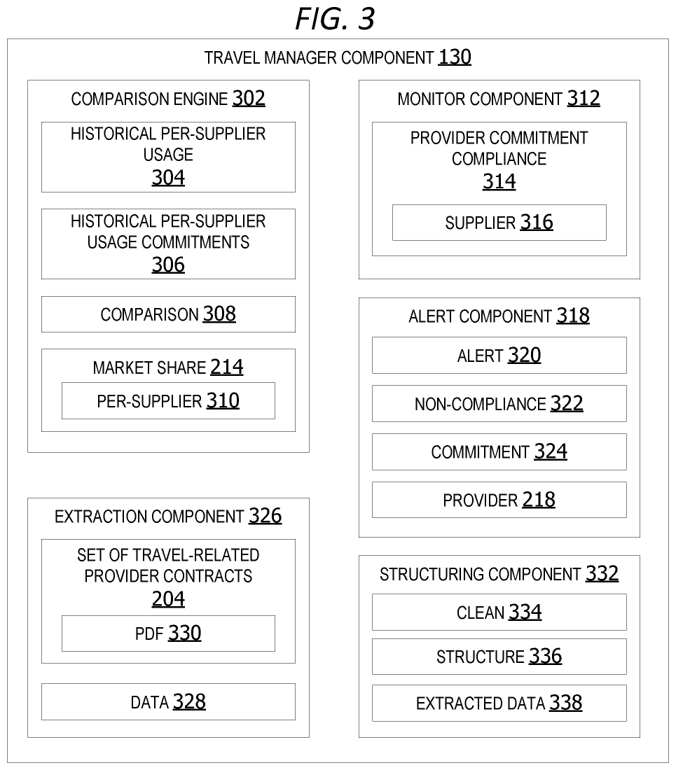

FIG. 3 is an exemplary block diagram illustrating a travel manager component 130 for extracting travel-related data 134 from contracts. A comparison engine 302 performs a comparison 308 of historical per-supplier usage 304 and per-supplier usage commitments 306 associated with the set of travel-related provider contracts 204 to determine per-supplier 310 market share 214.

A monitor component 312 monitors provider commitment compliance 314 for each supplier 316 in the set of travel-related providers. An alert component 318 outputs an alert 320 to at least one user on condition non-compliance 322 with at least one commitment 324 associated with at least one provider 218 is detected.

An extraction component 326 extracts data 328 associated with at least one term from the set of travel-related provider contracts 204 in a PDF 330. In other examples, the data is extracted from one or more contracts in a word (non-PDF) format.

A structuring component 332 cleans 334 and structures 336 the extracted data 338 for storage. The structuring component stores the extracted data 338 in at least one database associated with the data storage device.

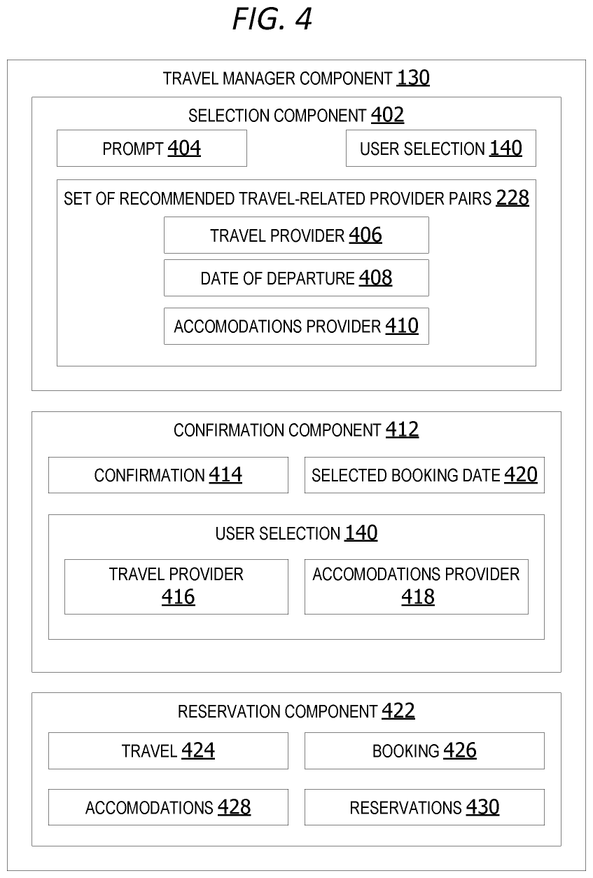

FIG. 4 is an exemplary block diagram illustrating a travel manager component 130 for booking user-selected travel and accommodations. A selection component 402 outputs a prompt 404 requesting user selection 140 of a travel provider 406, date of departure 408 and an accommodations provider 410 from the set of recommended travel-related provider pairs 228.

A confirmation component 412 obtains confirmation 414 of user selection of the travel provider 416, the date of departure 408, the accommodations provider 418 and/or a selected booking date 420. A reservation component 422 performs booking 426 of travel 424 via the travel provider. The reservation component 422 makes reservations 430 for accommodations 428 associated with the accommodations provider at the destination on the selected booking date.

In this manner, the system can provide contract extraction which automatically handles different PDF formats and extracts relevant information to store it in a database after cleaning and structuring. An audit component tracks market share and realized discount in real-time, checks compliance with existing contract and provides alerts when needed. The optimization component learns from historical transactions and past contracts. The system optimizes against different combinations of airlines (or hotels) and market pairs to provide the best contract terms within the power of negotiation of travel team, ensuring maximum savings. The travel booking component incorporates important derived variables from historical transactions, contract compliance history into a predictive model which is used to provide the best combination of airline(s), hotel(s), travel dates and booking date.

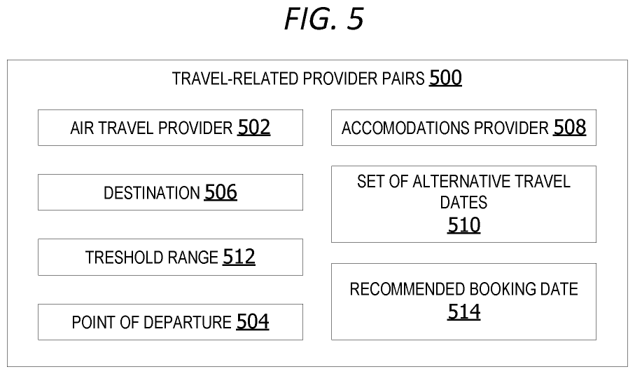

FIG. 5 is an exemplary block diagram illustrating a travel-related provider pair 500. The travel-related provider pair 500 includes an air travel provider 502 providing flights from a point of departure 504 and a destination 506. The travel-related provider pair 500 also includes an accommodations provider 508 having available accommodations for a user at or near the destination 506. In other words, the accommodations provider 508 has accommodations (hotel room) available for reservation at a location that is within a user-selected distance or range from the destination.

The destination can be the airport arrival location or some other destination. The travel-related provider pair 500 can optionally include a set of alternative travel dates 510 within a threshold range (time-period) of the user's selected travel date(s). The travel-related provider pair 500 can also include a recommended booking date 514. The recommended booking date 514 is a recommended date for making hotel reservations or booking a flight with a selected travel provider (airline).

FIG. 6 is an exemplary block diagram illustrating a database 600 storing travel-related data. The travel-related data can include a set of travel-related provider contracts 204. The set of travel-related provider contracts 204 can include one or more air travel provider contract(s) 602 and/or one or more accommodation provider contract(s) 604. In other examples, the set of travel-related provider contracts 204 can include passenger train travel providers, cruise ship travel providers, or providers of any other type of travel services.

The set of travel-related providers 220 can include one or more accommodation providers 606 and/or one or more travel providers 608. A travel provider 608 can include air travel providers 610, rail travel providers 611 or any other type of travel provider.

User-provided preferences 612 are preferences of the user. The preferences can include class of travel 614, source-to-destination pair 616, preferred date of travel 622, mode of travel 624 and/or predetermined range 626 of travel dates from the preferred date of travel. The source-to-destination pair 616 includes a destination 618 and a point of departure 620.

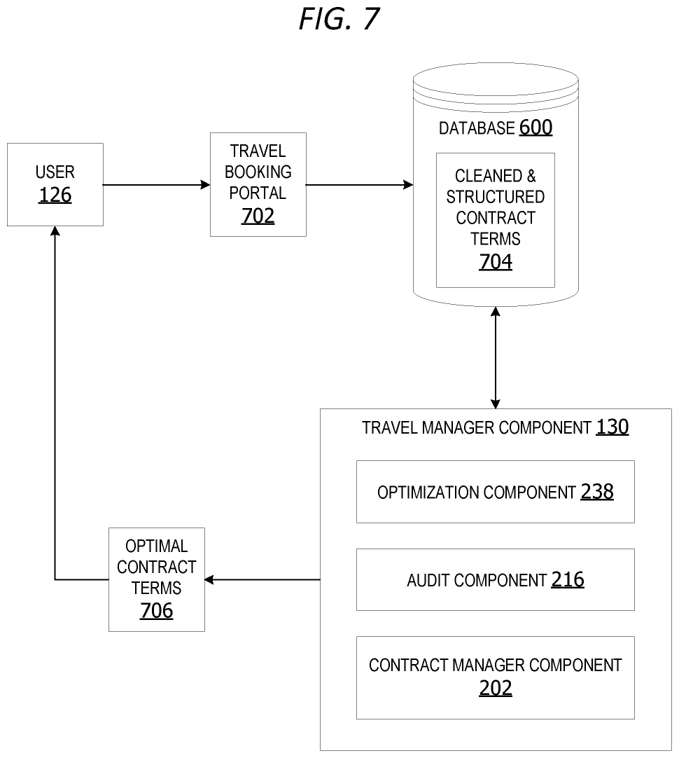

FIG. 7 is an exemplary block diagram illustrating travel-related provider contract optimization by a travel manager component 130. In this example, a user 126 utilizes the travel booking portal to book travel and/or accommodations based on contract terms. The database 600 stores cleaned and structured contract terms 704. The optimization component 238 analyzes the travel-related data to generate optimal contract terms 706. The contract manager component 202 extracts relevant data from existing travel-related contracts. The extracted data is cleaned and structured for storage on the database 600 by the contract manager component 202. The audit component 216 monitors travel and accommodations usage by the users. This audit data is utilized to generate/update the optimal contract terms 706. The optimal contract terms are used by travel team members to negotiate contract terms and conditions with hotels and air travel providers.

In some examples, the system provides two separate portals. One portal exists for airline (travel provider) contracts. The other portal is provided for hotel (accommodations) contracts where the travel team or other user can log in and perform actions, such as, but not limited to, parsing already finalized contract files, monitoring compliance with the existing contract terms and/or running an optimization model which suggest the optimal discount rates for the next phase of contract negotiation. The system, in some examples, parses raw contract files using extraction techniques. The extraction techniques can include, but is not limited to, optical character resolution (OCR) techniques, regular expression-based extraction techniques etc. The system cleans and stores extracted information in a structured database. The database can also store the data related to historical bookings.

The above two data sources in some examples are used to create a dashboard which, for a given source-destination pair, compares the actual discount rates and negotiated discount rates. The system outputs alerts for any major deviation that should be reviewed by one or more users. A similar dashboard is provided in some examples to monitor per-provider market share, as well. The dashboard also notifies the user (travel team) if a contract approaches its end date (contract expiry date).

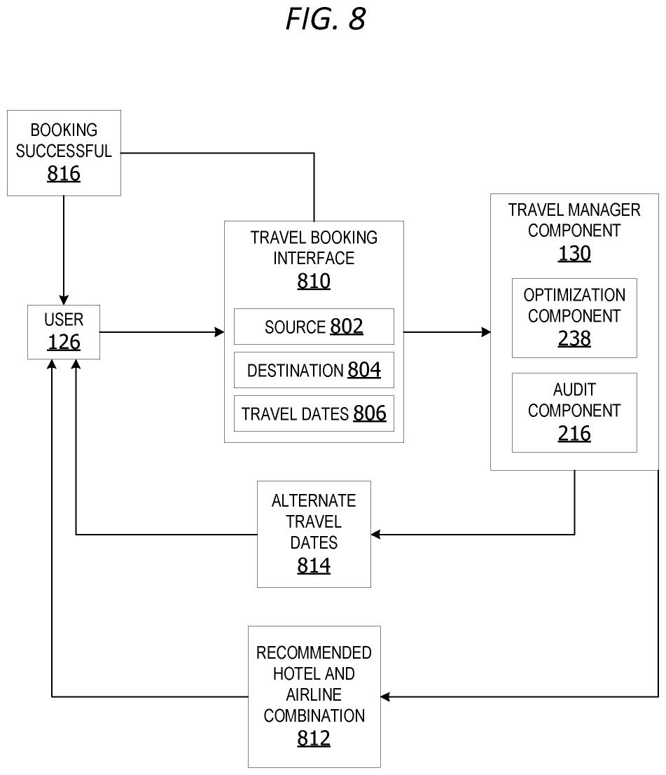

FIG. 8 is an exemplary block diagram illustrating travel booking by a travel manager component 130. The user 126 provides source 802, destination 804 and travel dates 806 to the travel manager component 130 via the travel booking interface 810. The travel booking interface 810 is generated via a user interface, such as, but not limited to, the user interface device 110 in FIG. 1.

The audit component 216 in some examples generates market share for each provider based on travel and accommodations usage. The optimization component 238 generates recommended hotel and airline combination 812 and/or provides alternate travel dates 814 to the user 126 based on the user's travel preferences. The user selects a travel provider, an accommodations provider and a booking date from the recommendations. The travel booking interface makes the hotel reservations and books the flight on the user's selected booking date. The travel booking interface 810 notifies the user 126 if the booking is successful 816 in this non-limiting example.

In another example, the system provides a third portal at which a user can book a trip and/or hotel accommodations. The user can log in to the interface and select a source-destination pair, as well as preferred travel dates and travel class. This information is then fed into an optimization model. The market shares met for different airlines and hotels are also fed into the same model. Based on the pre-defined holiday calendar of the source and destination, different calendar variables (which may include but not limited to weekday/weekend, day of the week, holiday etc.) are derived from the preferred travel dates and fed to the optimization model.

The driving factors for variation in price in some examples are determined from historical transactions using combination of non-linear analysis of covariance (ANCOVA) and time series analysis, leading to a predictive model which feeds into the mixed integer programming optimization engine.

Based on these inputs, the system returns the best combination of airline(s) and hotel(s), alternate travel dates within a certain range of the preferred date and the best date to book the ticket for the trip, taking into consideration any additional user-defined constraints. These recommendations are shown to the user in the interface who can then confirm the choices suggested by the model. Once confirmed, the bookings for the selected airline(s) and hotel(s) will be completed and the booking information will be stored back to the previously mentioned database.

In some examples, if none of the recommended choices work for the user, the system provides all possible combinations of airline, travel, dates, etc. The system continues offering recommendations until the user selects a workable option.

FIG. 9 is an exemplary flow chart illustrating operation of the computing device to book travel and accommodations for a user. The process shown in FIG. 9 is performed by a travel manager component, executing on a computing device, such as the computing device 102 or the user device 120 in FIG. 1.

The process begins by receiving user-provided travel preferences at 902. The user-provided preferences includes one or more travel-related preferences, such as, but not limited to, the user-provided preferences 612 in FIG. 6. The preferences 612 analyzes the travel-related data extracted from a set of travel-related provider contracts and historical transaction data at 904. The travel manager component calculates market share for each provider at 906. The travel manager component generates a set of recommended travel-related provider pairs at 908. The travel manager component determines if a user-selection is received at 910. If yes, the travel manager component books travel and accommodations associated with selected travel provider and accommodations provider for the selected travel date at 912. The process terminates thereafter.

While the operations illustrated in FIG. 9 are performed by a computing device, aspects of the disclosure contemplate performance of the operations by other entities. In a non-limiting example, a cloud service performs one or more of the operations.

FIG. 10 is an exemplary flow chart illustrating operation of the computing device to generate a set of recommended negotiation terms. The process shown in FIG. 10 is performed by a travel manager component, executing on a computing device, such as the computing device 102 or the user device 120 in FIG. 1.

The process begins by extracting relevant travel-related data from a set of travel-related provider contracts in PDF format at 1002. The travel manager component stores extracted data in a data store at 1004. The data store can be implemented on a data storage device, such as, but not limited to, the data storage device 132 in FIG. 1. The travel manager component analyzes extracted data and historical travel-usage data to calculate market share for each provider at 1006. The travel manager component determines whether to make a recommendation regarding terms for negotiations at 1008. If yes, the travel manager component generates a set of recommended future negotiation terms associated with a provider at 1010. The process terminates thereafter.

While the operations illustrated in FIG. 10 are performed by a computing device, aspects of the disclosure contemplate performance of the operations by other entities. In a non-limiting example, a cloud service performs one or more of the operations.

FIG. 11 is an exemplary graph 1100 illustrating objective function for contract optimization. The contract optimization component takes into consideration past travel transactions, historical contract information and forecasted demand and price to provide the best realistic discounts, within the negotiation realm, to ensure maximum savings.

In some examples, the travel manager component utilizes a constrained quadratic optimization model to arrive at the optimal discounts for a given provider pair or source-destination pair. It also allows the user to run various what-if scenarios on top of the suggested discount percentages and see its effect on other market pairs/hotels.

The optimization in this example is done at the airline-market pair level or hotel chain-hotel pair level. The objective is to minimize the overall travel cost or price for an airline across different market pairs or hotel-chains across different hotels. The objective function in one example is as follows:

$${min}_{{d}_{i}} {Σ}_{i} {Σ}_{j} {P}_{i j} ( 1 - {d}_{i} ) \\ {max}_{{d}_{i}} {Σ}_{i} {Σ}_{j} {P}_{i j} {d}_{i}$$

where Pᵢⱼ=price of the j^{th} transaction in i^{th} market pair and dᵢ=discount for i^{th} market-pair. The market pair is the source to destination combination. The constraints are as follows:

0≤dᵢ≤1

dᵢ^{l}≤dᵢ≤dᵢ^{u}∀i,

where dᵢ^{l} equals the lowest discount in last year's contract. The highest discount in last year's contract is represented by dᵢ^{u}. Another constraint can be imposed on the forecasted demand Dᵢ as follows:

Σdᵢ×Dᵢ×Pᵢ>s,

where Pᵢ=forecasted average price and s=savings for last year. The minimum average discount is calculated as follows:

$$\frac{{Σ}_{i} {D}_{i} {d}_{i}}{{Σ}_{i} {D}_{i}} \leq {d}_{i}^{m} , \\ {d}_{i}^{m} = \frac{{Σ}_{i} {D}_{i} {d}_{i}^{r}}{{Σ}_{i} {D}_{i}}$$

where dᵢ^{r} is equal to the realized discount. The discount is a value between zero and one.

The last equation ties all market pairs in the optimization model by restricting the weighted average of all new discounts to be greater than a certain threshold denoted by dᵢ^{m}.

The optimal discount cannot be very different from last year's contract discount. The system includes a penalty term which penalizes the cost function if the discount is very far from the contract discount. The updated objective function including the penalty term represented in the graph 1100 is as follows:

$${max}_{{d}_{i}} {Σ}_{i} {Σ}_{j} {P}_{i j} {d}_{i} - k * {Σ}_{i} ( {d}_{i} - {d}_{c}^{l} ) ( {d}_{i} - {d}_{c}^{u} )$$

where k is equal to

$$\frac{{Σ}_{t} {Σ}_{j} {P}_{t j} ( {d}_{t}^{u} - {d}_{t}^{l} )}{max \{ ( \vert {Σ}_{i} ( {d}_{i}^{u} - {d}_{c}^{l} ) ( {d}_{i}^{u} - {d}_{c}^{u} ) \vert , \vert {Σ}_{i} ( {d}_{i}^{l} - {d}_{c}^{l} ) ( {d}_{i}^{l} - {d}_{c}^{u} ) \vert ) \}} ,$$

and k is chosen such that both the terms are comparable.

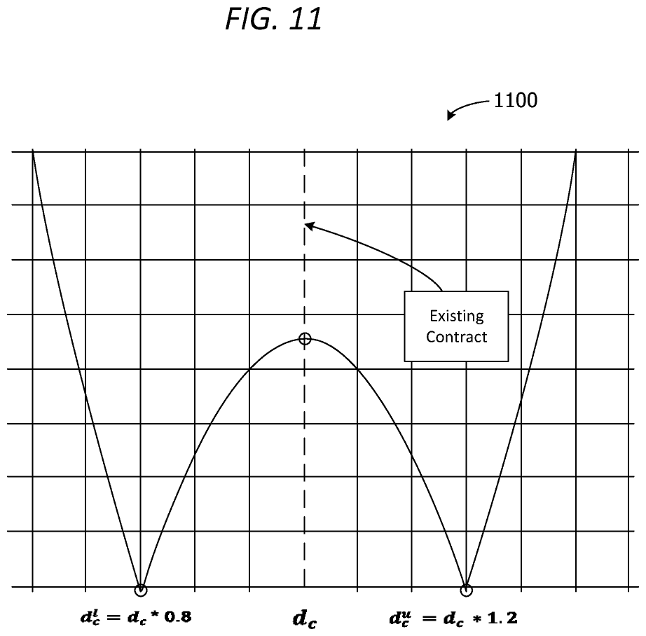

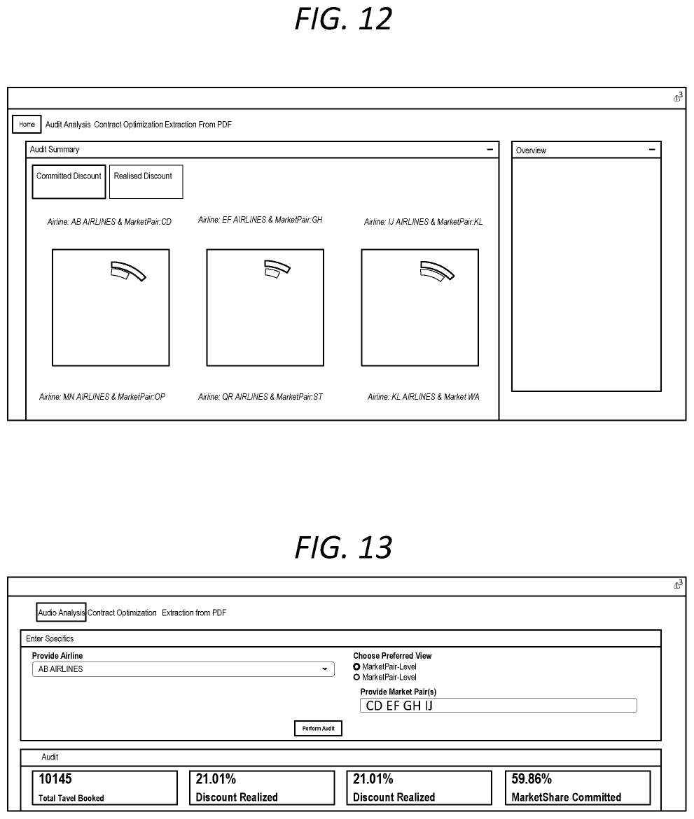

FIG. 12 is an exemplary screenshot 1200 illustrating a home page for a travel manager system. The screenshot 1200 includes a non-limiting example of the homepage including an audit summary identifying three airline-market pair combinations showing the committed discount and the realized discount associated with each travel provider. The system shows the most significant deviation from contract so far, for domestic and/or international trip types. The system in some examples, provides relevant instructions to the user regarding travel management associated with one or more providers.

In this non-limiting example, the system highlights provider market pair combination with most significant deviation from the contract. Deviation refers to deviation in terms of both discount and market share.

FIG. 13 is an exemplary screenshot 1300 illustrating audit analysis inputs and metrics. The audit analysis for a selected provider lays out the status quo for the compliance of the latest contract so far with the provider. This helps the user track progress or deviation from the contract in real-time. In this non-limiting example, the audit analysis provide total travel booked, discount realized, market share realized and market share committed for the selected provider.

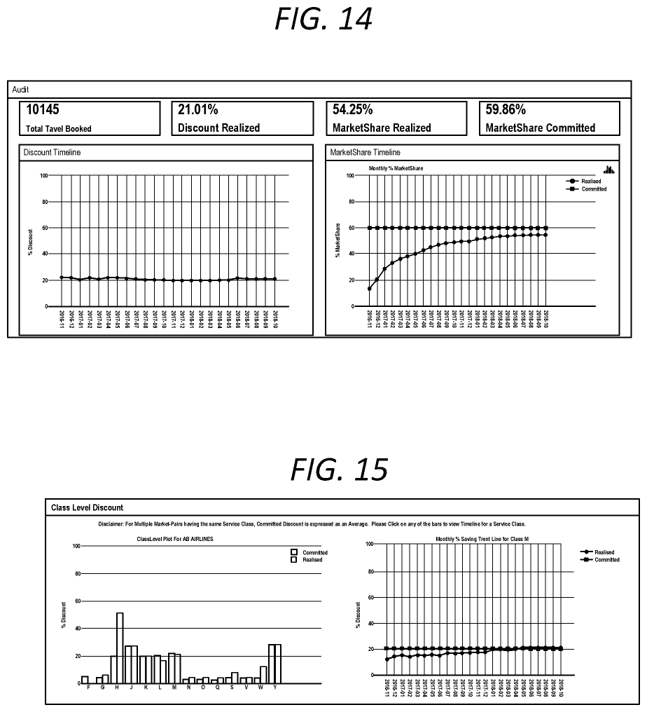

FIG. 14 is an exemplary screenshot 1400 illustrating audit analysis market share and discount. In this non-limiting example, the system studies historical transaction data from the start of the contract period to the present and summarizes the results in a discount timeline graph and a market share timeline.

The discount timeline shows a monthly trend for cumulative realized discount averaged over all classes. The market share timeline shows monthly trend for cumulative realized and committed market share averaged over all classes.

FIG. 15 is an exemplary screenshot 1500 illustrating audit analysis discount over service class. In this non-limiting example, the system studies historical transaction data from the start of the contract period to the present and summarizes the results in a class level plot and a monthly percentage saving trend over time.

The class level discount group bar chart shows realized and committed discount for every class for a given combination of airline and market pair term. The timeline chart shows monthly trend for cumulative realized and committed discount for the chosen class.

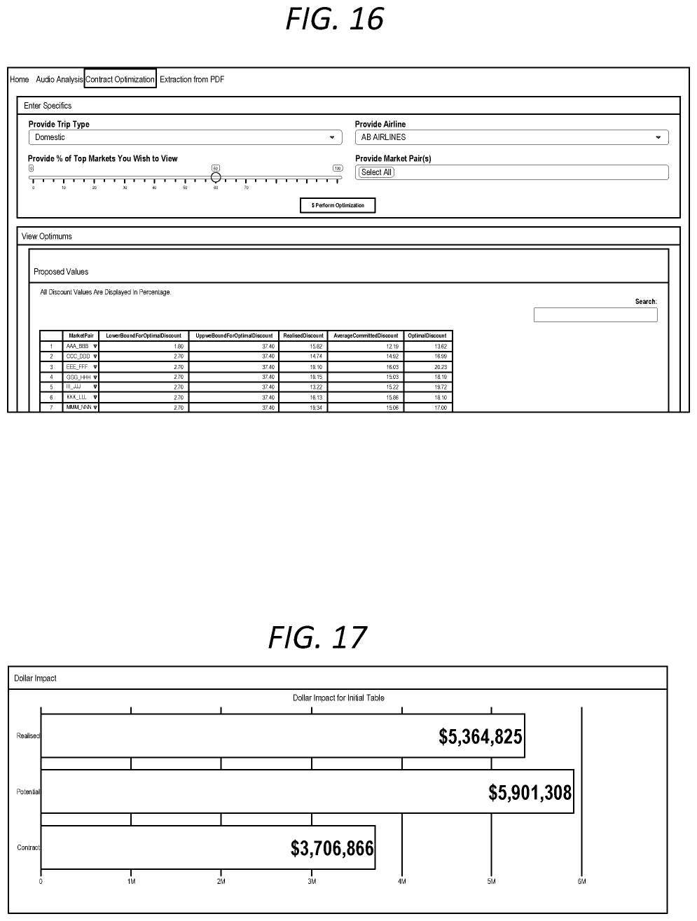

FIG. 16 is an exemplary screenshot 1600 illustrating contract optimization. The system optimization aids the user in obtaining discount rates based on business inputs and historical transaction data. The user is given the flexibility to alter suggested discount rates/bounds for specific cases and re-run the set-up. The optimization tab works at market pair level.

The “provide % of top markets” selector enables a user to provide percentage. Markets for every combination of airline and trip type are ranked according to the number of travel in each route. The top markets are chosen from ranked list according to the percentage provided by the user. The user can select multiple markets from a drop-down menu. The “run optimization” selector enables the user to run the optimization with all the previously selected options.

The table in this example has three editable columns, the second column, the third column and the fifth column. The user can either edit the optimal discount column for a certain market pair or edit the lower/upper bounds column for the same market pair. The user can also edit the optimal discount for one market pair and edit the discount bounds for another market pair. However, the user cannot fix the optimal and discount bounds for the same market pair at one time. A particular optimal discount, once edited, remains at its set value and the optimization is run afresh for the remaining markets once the re-run optimization button is selected (clicked on).

For edit in discount bounds [lower/upper], optimal discount is suggested within the edited bound for a certain market pair. The lower bound should not exceed the upper bound for a particular market pair. The user can make as many edits as they want, as long as the edits comply with the first three conditions.

FIG. 17 is an exemplary screenshot 1700 illustrating dollar impact for contract optimization. In this example, the system outputs realized dollar impact, potential dollar impact and contract dollar impact for optimization. This shows the realized, potential and the contract dollar savings for the most recently run optimization.

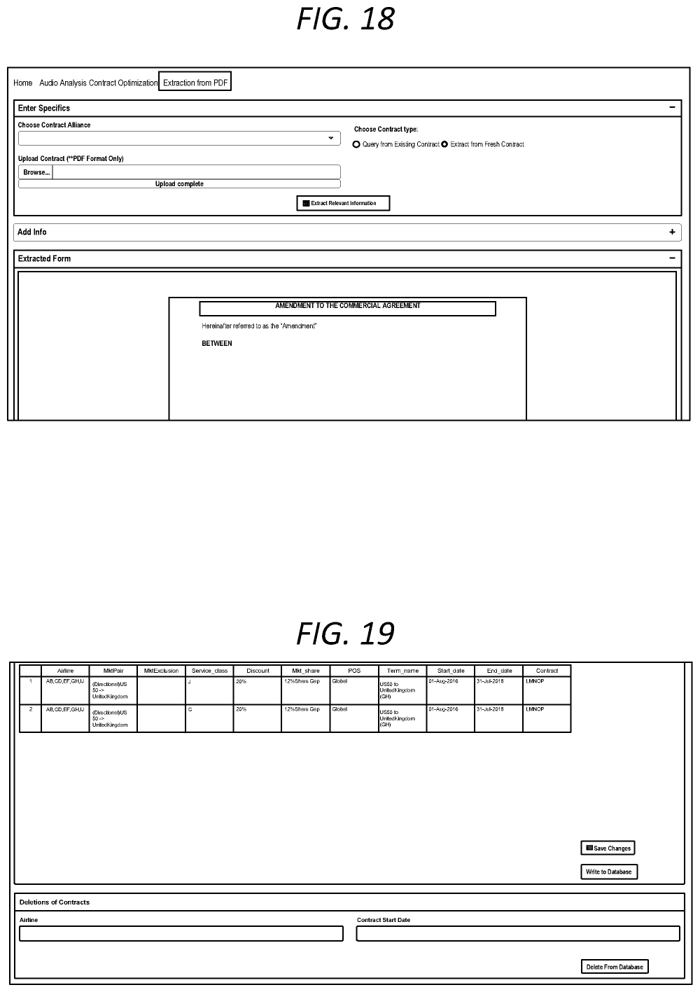

FIG. 18 is an exemplary screenshot 1800 illustrating contract data extraction. The system extracts relevant variables from PDF documents and queries the data for optimizing travel decisions and contract negotiations. The contract manager helps the user query from past contract data. It lets the user automatically update the contract database either by uploading contract PDF files or filling up contract upload form. The system can display the past contracts at both term and market-pair level. The interface has a PDF view to help the user compare the extracted contract with the original PDF file and validate it.

FIG. 19 is an exemplary screenshot 1900 illustrating contract data extraction and deletion. The system extracts market pairs, service class, discount percentage, contract start date, end date of contracts, and other relevant contract terms. The extracted data is displayed in the form of an editable table, such as, but not limited to, the table 1900.

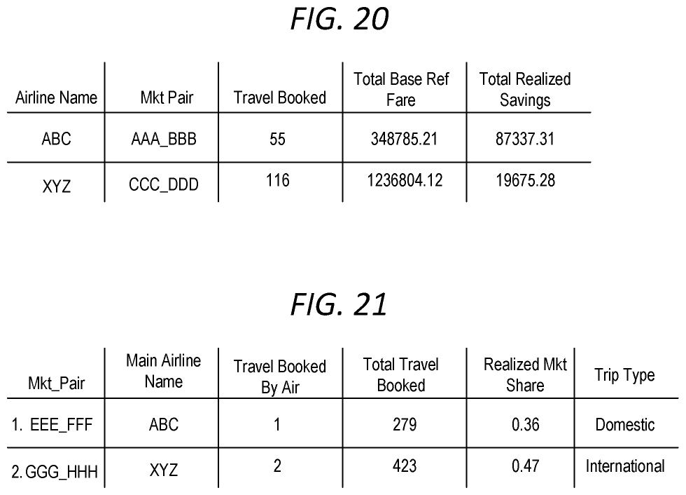

FIG. 20 is an exemplary table 2000 illustrating discount difference data. The table in this non-limiting example includes provider name, market pair, travel booked, total base reference fare, and total realized savings associated with each provider.

FIG. 21 is an exemplary table 2100 illustrating market share audit reporting data. In this example, the table 2100 includes an identification of each market pair, the provider name, travel booked by air, total travel booked, realized market share, and trip type (domestic or international).

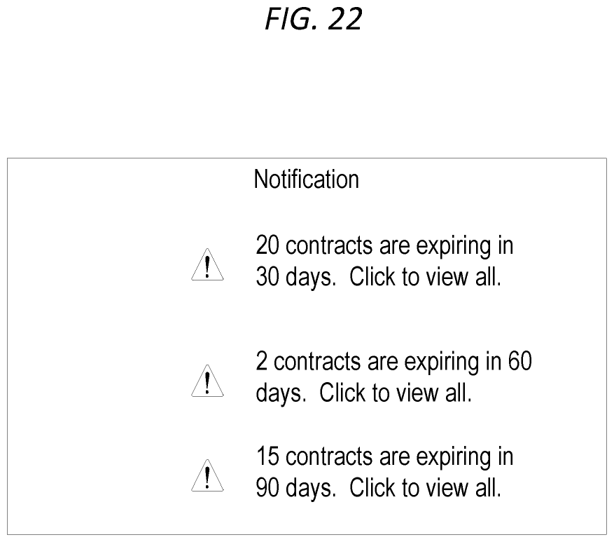

FIG. 22 is an exemplary screenshot 2200 illustrating alert notification. In this non-limiting example, the alert notification includes identification of contracts expiring in thirty days, contracts expiring in sixty days and contracts expiring in ninety days. The notification alerts users to renew contracts, negotiate new contracts or otherwise take appropriate action in preparation for expiration of a given provider contract.

### Additional Examples

Some examples provides an end-to-end travel assistant system that optimizes future contract negotiations, monitors compliance with existing contract terms, parses finalized contracts and assists users in selecting cost-effective airline and hotel combinations for travel at the time of booking. The travel management system in other examples optimizes contract negotiations with airlines and/or hotels to obtain maximum discounts and other incentives by analyzing historic travel-related services usage and previous provider contracts to generate recommended discount percentages for source-destination pairs and/or recommended usage percentages for commitments with travel-related providers.

The system in still other examples learns from historical transactions and past contracts to optimize different combinations of providers and market shares to provide the best contract terms within the power of the negotiation travel team to ensure maximum savings. This assists users with contract negotiations and ensures contracts resulting from negotiations are profitable for contracting parties.

The contract manager component in some examples includes an airline portal associated with one or more air travel providers and a hotel portal associated with one or more accommodations providers. Each portal includes an optimization component for recommending optimal discount rates for different source-destination pairs or different hotels.

In other examples, the system provides a single portal for the user to select an airline and a hotel provider for a trip. When the user selects an option, the booking component books/makes reservations at a second booking portal. This gives a first portal for hotel and airline booking. A second portal is provided for travel team to check discount percentage, discount rates, etc. The second portal provides contract term optimization for negotiations.

An audit component in other examples compares booked travel with contract commitments. The audit engine tracks market share and realized discount in real-time. The system checks compliance with existing contracts and provides alerts associated with any failures to meet agreed usage percentages.

A contract manager component extracts contract terms and conditions from prioritized PDF provider contracts. The contract manager automatically handles different PDF formats and extracts relevant information to store in a database after cleaning and structuring the data in other examples. The system automatically extracts, cleans and stores the contract data to eliminating manual effort by users previously required to perform these tasks.

In other examples, a booking management component provides a portal which receives user-preferred travel dates and class of travel as input. An optimization model runs in the background and returns the best combination of airline and hotel for a given users trip based on the user's travel preferences. The system takes into account market share and discount percentages while planning user travel arrangements.

The system optimizes and incorporates important derived variables from historic transaction and contract compliance history into a predictive model which is used to provide the best combinations of air travel, hotel, travel dates and booking dates. This enables optimal booking of travel and accommodations for trips to lower travel expenditures and maximize available discounts.

Alternatively, or in addition to the other examples described herein, examples include any combination of the following:
wherein the user-provided travel preferences comprises the source-to-destination pair, the user-preferred date of travel and a user-preferred class of travel;
a selection component, implemented on the at least one processor, outputs a prompt requesting the user select a travel provider, date of departure and an accommodations provider from the set of recommended travel-related provider pairs;
the set of recommended travel-related provider pairs further comprises at least one air travel provider, at least one accommodations provider associated with the destination, a set of alternative travel dates within a threshold range of the user provided preferred travel date and a recommended booking date;
a confirmation component, implemented on the at least one processor, confirms user selection of the travel provider, the date of departure, the accommodations provider and a selected booking date;
a reservation component, implemented on the at least one processor, books travel via the travel provider and reserves accommodations associated with the accommodations provider at the destination on the selected booking date;
a comparison engine, implemented on the at least one processor, compares historical per-supplier usage with per-supplier usage commitments associated with the set of travel-related provider contracts to determine per-supplier market share;
a monitor component, implemented on the at least one processor, monitors provider commitment compliance for each supplier in the set of travel-related providers;
an alert component, implemented on the at least one processor, outputs an alert to at least one user on condition non-compliance with at least one commitment associated with at least one provider is detected;
an extraction component, implemented on the at least one processor, extracts data associated with at least one term from the set of travel-related provider contracts in a portable document format (PDF);
a structuring component, implemented on the at least one processor, cleans and structures the extracted data for storage;
a structuring component, implemented on the at least one processor, stores the extracted data in at least one database associated with the data storage device;
receiving, via a user interface device, a set of user-provided travel preferences, including a source-to-destination pair identifying a point of departure and a travel destination, a user-preferred date of travel, an acceptable threshold range of travel dates and a user-preferred class of travel;
analyzing, by a contract manager component, relevant travel-related data from a set of travel-related provider contracts with historical transaction data associated with air travel and accommodations usage to calculate market share for each provider in a set of travel-related providers;
generating, by a booking component, a set of recommended travel-related provider pairs compliant with the user-provided travel preferences, the set of recommended travel-related provider pairs comprising at least one air travel provider associated with the source-to-destination pair and class of travel, at least one accommodations provider associated with the destination and a set of travel dates within the acceptable threshold range of travel dates;
booking, by a reservation component, travel and accommodations associated with an air travel provider and accommodations provider selected from the set of recommended travel-related provider pairs for a travel date selected from the set of travel dates;
generating, by an optimization component, a set of recommended future negotiation terms associated with at least one provider in the set of travel-related providers based on the historical travel usage data, historical transaction data and historical contract compliance data;
outputting, by a selection component, a prompt requesting the user select an air travel provider, date of departure and an accommodations provider from the set of recommended travel-related provider pairs;
the set of recommended travel-related provider pairs further comprises at least one air travel provider, at least one accommodations provider associated with the destination, a set of alternative travel dates within a threshold range of the user provided preferred travel date and a recommended booking date;
booking, by a booking component, air travel and accommodations on the recommended booking date;
comparing, by a comparison engine, historical per-supplier usage with per-supplier usage commitments associated with the set of travel-related provider contracts to determine per-supplier market share;
monitoring, by a monitor component, provider commitment compliance for each supplier in the set of travel-related providers;
generating, by an alert component, an alert to at least one user on condition non-compliance with at least one commitment associated with at least one provider is detected;
extracting data associated with at least one term from the set of travel-related provider contracts in a PDF;
structuring the extracted data for storage;
saving the extracted data in at least one database associated with the data storage device;
monitoring contract termination dates associated with each contract in the set of travel-related provider contracts;
outputting an alert to at least user on condition expiration of a selected contract has occurred or is expected to occur within a predetermined threshold time-period;
extracting relevant travel-related data from a set of travel-related provider contracts in a PDF format;
storing the extracted relevant travel-related data on a data storage device;
analyzing the extracted relevant travel-related data and historical travel usage data to calculate a market share for each provider in a set of travel-related providers;
generating a set of recommended future negotiation terms associated with at least one provider in the set of travel-related providers based on the historical travel usage data, historical transaction data and historical contract compliance data;
analyzing a set of user-provided travel preferences and the calculated market share associated with each provider in the set of travel-related providers using the extracted relevant travel-related data to generate a set of recommended travel-related provider pairs associated with a set of travel dates within a predetermined range of a user-selected preferred date of travel associated with a user-selected source-to-destination pair on a user interface device associated with the user;
outputting the set of recommended travel-related provider pairs, including at least one air travel provider associated with the source-to-destination pair, at least one accommodations provider associated with the destination, at least one travel date within the threshold range of the user-preferred travel date and a recommended booking date;
outputting a prompt requesting the user select an air travel provider, date of departure and an accommodations provider from the set of recommended travel-related provider pairs on a user interface device;
extracting data associated with at least one term from the set of travel-related provider contracts in a PDF;
structuring the extracted data for storage;
saving the extracted data in at least one database associated with the data storage device.

At least a portion of the functionality of the various elements in FIG. 1, FIG. 2, FIG. 3, FIG. 4, FIG. 5, FIG. 6, FIG. 7 and FIG. 8 can be performed by other elements in FIG. 1, FIG. 2, FIG. 3, FIG. 4, FIG. 5, FIG. 6, FIG. 7 and FIG. 8, or an entity (e.g., processor 106, web service, server, application program, computing device, etc.) not shown in FIG. 1, FIG. 2, FIG. 3, FIG. 4, FIG. 5, FIG. 6, FIG. 7 and FIG. 8.

In some examples, the operations illustrated in FIG. 9 and FIG. 10 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for managing customized travel plans. For example, the elements illustrated in FIG. 1, FIG. 2, FIG. 3, FIG. 4, FIG. 5, FIG. 6, FIG. 7 and FIG. 8, such as when encoded to perform the operations illustrated in FIG. 9 and FIG. 10, constitute exemplary means for receiving a set of user-provided travel preferences, including a source-to-destination pair identifying a point of departure and a travel destination, a user-preferred date of travel, an acceptable threshold range of travel dates and a user-preferred class of travel; exemplary means for analyzing relevant travel-related data from a set of travel-related provider contracts with historical transaction data associated with air travel and accommodations usage to calculate market share for each provider in a set of travel-related providers; exemplary means for generating a set of recommended travel-related provider pairs compliant with the user-provided travel preferences; and exemplary means for booking travel and accommodations associated with an air travel provider and accommodations provider selected from the set of recommended travel-related provider pairs for a travel date selected from the set of travel dates.

Other non-limiting examples provide one or more computer storage devices having a first computer-executable instructions stored thereon for providing customized travel management. When executed by a computer, the computer performs operations including extracting relevant travel-related data from a set of travel-related provider contracts in a PDF format; storing the extracted relevant travel-related data on a data storage device; analyzing the extracted relevant travel-related data and historical travel usage data to calculate a market share for each provider in a set of travel-related providers; and generating a set of recommended future negotiation terms associated with at least one provider in the set of travel-related providers based on the historical travel usage data, historical transaction data and historical contract compliance data.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of.” The phrase “one or more of the following: A, B, and C” means “at least one of A and/or at least one of B and/or at least one of C.”

In an exemplary embodiment, one or more of the exemplary embodiments include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly. For example, whenever localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data can include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI can be discarded depending upon the degree to which such KRI has any value based on local processing and evaluation of such KRI. In an exemplary embodiment, KRI may not even be utilized in any form if it is determined that KRI is transient and can be considered as signal noise. Furthermore, in an exemplary embodiment, the kernel rejects generic data to provide a modified kernel (“KRG”) by filtering incoming raw data using a stochastic filter that thereby provides a predictive model of one or more future states of the system and can thereby filter out data that is not consistent with the modeled future states which can, for example, reflect generic background data. In an exemplary embodiment, KRG incrementally sequences all future undefined cached kernels of data to filter out data that can reflect generic background data. In an exemplary embodiment, KRG further incrementally sequences all future undefined cached kernels having encoded asynchronous data to filter out data that can reflect generic background data.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for customized travel planning management, the system comprising:
a memory;
at least one processor communicatively coupled to the memory;
a contract manager component, implemented on the at least one processor, extracts relevant travel-related data from a set of travel-related provider contracts, the set of travel-related provider contracts comprising a set of air-travel provider contracts and a set of accommodations provider contracts;
a data storage device configured to store the extracted relevant travel-related data;
an audit component, implemented on the at least one processor, analyzes the extracted relevant travel-related data and historical travel usage data to calculate a market share for each provider in a set of travel-related providers, the set of travel-related providers comprising a set of accommodations providers and a set of travel providers;
a booking manager component, implemented on the at least one processor, analyzes a set of user-provided travel preferences and the calculated market share using the extracted relevant travel-related data to identify a set of recommended travel-related provider pairs associated with a set of travel dates within a predetermined range of a user-selected preferred date of travel associated with a user-selected source-to-destination pair on a user interface device associated with the user, the set of recommended travel-related provider pairs comprising at least one travel provider and an accommodations provider pair; and
an optimization component, implemented on the at least one processor, generates a set of recommended future negotiation terms associated with at least one provider in the set of travel-related providers based on the historical travel usage data, historical transaction data and historical contract compliance data.

2. The system of claim 1, wherein the user-provided travel preferences comprises the source-to-destination pair, the user-preferred date of travel and a user-preferred class of travel.

3. The system of claim 1, further comprising:
a selection component, implemented on the at least one processor, outputs a prompt requesting the user select a travel provider, date of departure and an accommodations provider from the set of recommended travel-related provider pairs.

4. The system of claim 1, wherein the set of recommended travel-related provider pairs further comprises at least one air travel provider, at least one accommodations provider associated with the destination, a set of alternative travel dates within a threshold range of a preferred travel date and a recommended booking date.

5. The system of claim 1, further comprising:
a confirmation component, implemented on the at least one processor, confirms user selection of the travel provider, date of departure, an accommodations provider and a selected booking date; and
a reservation component, implemented on the at least one processor, books travel via the travel provider and reserves accommodations associated with the accommodations provider at the destination on the selected booking date.

6. The system of claim 1, further comprising:
a comparison engine, implemented on the at least one processor, compares historical per-supplier usage with per-supplier usage commitments associated with the set of travel-related provider contracts to determine per-supplier market share.

7. The system of claim 1, further comprising:
a monitor component, implemented on the at least one processor, monitors provider commitment compliance for each supplier in the set of travel-related providers; and
an alert component, implemented on the at least one processor, outputs an alert to at least one user on condition non-compliance with at least one commitment associated with at least one provider is detected.

8. The system of claim 1, further comprising:
an extraction component, implemented on the at least one processor, extracts data associated with at least one term from the set of travel-related provider contracts in a portable document format (PDF); and
a structuring component, implemented on the at least one processor, cleans and structures extracted data for storage, wherein the structuring component stores the extracted data in at least one database associated with the data storage device.

9. A computer-implemented method for managing customized travel plans, the computer-implemented method comprising:
receiving, via a user interface device, a set of user-provided travel preferences, including a source-to-destination pair identifying a point of departure and a travel destination, a user-preferred date of travel, an acceptable threshold range of travel dates and a user-preferred class of travel;
analyzing, by a contract manager component, relevant travel-related data from a set of travel-related provider contracts with historical transaction data associated with air travel and accommodations usage to calculate market share for each provider in a set of travel-related providers;
generating, by a booking component, a set of recommended travel-related provider pairs compliant with the user-provided travel preferences, the set of recommended travel-related provider pairs comprising at least one air travel provider associated with the source-to-destination pair and class of travel, at least one accommodations provider associated with the destination and a set of travel dates within an acceptable threshold range of travel dates; and
booking, by a reservation component, travel and accommodations associated with an air travel provider and an accommodations provider selected from the set of recommended travel-related provider pairs for a travel date selected from the set of travel dates.

10. The computer-implemented method of claim 9, further comprising:
generating, by an optimization component, a set of recommended future negotiation terms associated with at least one provider in the set of travel-related providers based on historical travel usage data, the historical transaction data and historical contract compliance data.

11. The computer-implemented method of claim 9, further comprising:
outputting, by a selection component, a prompt requesting the user select an air travel provider, date of departure and the accommodations provider from the set of recommended travel-related provider pairs.

12. The computer-implemented method of claim 9, wherein the set of recommended travel-related provider pairs further comprises at least one air travel provider, at least one accommodations provider associated with the destination, a set of alternative travel dates within a threshold range of a user-provided preferred travel date and a recommended booking date; and further comprising:
booking, by a booking component, air travel and accommodations on the recommended booking date.

13. The computer-implemented method of claim 9, further comprising:
comparing, by a comparison engine, historical per-supplier usage with per-supplier usage commitments associated with the set of travel-related provider contracts to determine per-supplier market share.

14. The computer-implemented method of claim 9, further comprising:
monitoring, by a monitor component, provider commitment compliance for each supplier in the set of travel-related providers; and
generating, by an alert component, an alert to at least one user on condition non-compliance with at least one commitment associated with at least one provider is detected.

15. The computer-implemented method of claim 9, further comprising:
extracting data associated with at least one term from the set of travel-related provider contracts in a PDF;
structuring extracted data for storage; and
saving the extracted data in at least one database associated with the data storage device.

16. The computer-implemented method of claim 9, further comprising:
monitoring contract termination dates associated with each contract in the set of travel-related provider contracts; and
outputting an alert to at least user on condition expiration of a selected contract has occurred or is expected to occur within a predetermined threshold time-period.

17. One or more computer storage devices, having computer-executable instructions for customizing travel plans that, when executed by a computer cause the computer to perform operations comprising:
extracting relevant travel-related data from a set of travel-related provider contracts in a PDF format;
storing the extracted relevant travel-related data on a data storage device;
analyzing the extracted relevant travel-related data and historical travel usage data to calculate a market share for each provider in a set of travel-related providers; and
generating a set of recommended future negotiation terms associated with at least one provider in the set of travel-related providers based on the historical travel usage data, historical transaction data and historical contract compliance data.

18. The one or more computer storage devices of claim 17, further comprising:
analyzing a set of user-provided travel preferences and the calculated market share associated with each provider in the set of travel-related providers using the extracted relevant travel-related data to generate a set of recommended travel-related provider pairs associated with a set of travel dates within a predetermined range of a user-selected preferred date of travel associated with a user-selected source-to-destination pair on a user interface device associated with the user; and
outputting the set of recommended travel-related provider pairs, including at least one air travel provider associated with the source-to-destination pair, at least one accommodations provider associated with the destination, at least one travel date within the threshold range of a user-preferred travel date and a recommended booking date.

19. The one or more computer storage devices of claim 17, further comprising:
outputting a prompt requesting the user select an air travel provider, date of departure and an accommodations provider from the set of recommended travel-related provider pairs on a user interface device.

20. The one or more computer storage devices of claim 17, further comprising:
extracting data associated with at least one term from the set of travel-related provider contracts in a PDF;
structuring extracted data for storage; and
saving the extracted data in at least one database associated with the data storage device.
